(19) United States
(12) Patent Application Publication
(10) Pub. No.: US 2025/0269818 A1
(43) Pub. Date: Aug. 28, 2025

(54) DETERMINATION OF A SAFETY ISSUE RELATING TO A VEHICLE OCCUPANT

(71) Applicant: Toyota Motor Engineering & Manufacturing North America, Inc., Plano, TX (US)

(72) Inventor: John D. Harkleroad, Ypsilanti, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/590,149

(22) Filed: Feb. 28, 2024

(51) Int. Cl. B60R 22/48; B60W 60/00; G06V 20/59

(52) U.S. Cl. CPC B60R 22/48; G06V 20/593; B60R 2022/4808; B60R 2022/4866; B60W 60/0015; B60W 2540/227; G06V 20/597

(57) ABSTRACT

Systems, methods, and other embodiments described herein relate to determining a safety issue relating to an occupant of a vehicle. In one embodiment, a method includes requesting, in response to a portion of the occupant being occluded in a first sensor data captured from a vehicle sensor in a vehicle cabin, a second sensor data from a mobile device capable of capturing second sensor data in the vehicle cabin. The method further includes determining, in response to the portion of the occupant that is occluded in the first sensor data being visible in the second sensor data, whether there is a safety issue.

### TECHNICAL FIELD

The subject matter described herein relates, in general, to systems and methods for determining whether there is a safety issue relating to an occupant of a vehicle.

### BACKGROUND

Modern vehicles include seatbelt sensors for detecting whether a seatbelt is securely fastened. The seatbelt sensors may determine that the seatbelt is securely fastened based on the latch plate being locked into the buckle. However, the seatbelt sensors may not accurately detect whether the occupant has the seatbelt straps properly placed across their torso.

### SUMMARY

This section generally summarizes the disclosure and is not a comprehensive explanation of its full scope or all its features.

In another embodiment, a system for determining whether there is a safety issue relating to an occupant of a vehicle is disclosed. The system includes a processor and a memory in communication with the processor. The memory stores machine-readable instructions that, when executed by the processor, cause the processor to request, in response to a portion of an occupant being occluded in a first sensor data captured from a vehicle sensor in a vehicle cabin, a second sensor data from a mobile device capable of capturing second sensor data in the vehicle cabin, and determine, in response to the portion of the occupant that is occluded in the first sensor data being visible in the second sensor data, whether there is a safety issue.

In one embodiment, a method for determining whether there is a safety issue relating to an occupant of a vehicle is disclosed. The method includes requesting, in response to a portion of an occupant being occluded in a first sensor data captured from a vehicle sensor in a vehicle cabin, a second sensor data from a mobile device capable of capturing second sensor data in the vehicle cabin, and determining, in response to the portion of the occupant that is occluded in the first sensor data being visible in the second sensor data, whether there is a safety issue.

In another embodiment, a non-transitory computer-readable medium for determining whether there is a safety issue relating to an occupant of a vehicle and including instructions that, when executed by a processor, cause the processor to perform one or more functions, is disclosed. The instructions include instructions to request, in response to a portion of an occupant being occluded in a first sensor data captured from a vehicle sensor in a vehicle cabin, a second sensor data from a mobile device capable of capturing second sensor data in the vehicle cabin, and determine, in response to the portion of the occupant that is occluded in the first sensor data being visible in the second sensor data, whether there is a safety issue.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle incorporating a vehicle occupant safety determination system.

FIGS. 2A-2C illustrate an example of a vehicle incorporating a vehicle occupant safety determination system as well as the first and second sensor data.

FIG. 3 is a more detailed block diagram of the vehicle occupant safety determination system of FIG. 2.

FIG. 4 is a flowchart illustrating one embodiment of a method associated with determining whether there is a safety issue relating to an occupant of a vehicle.

### DETAILED DESCRIPTION

Systems, methods, and other embodiments associated with determining a safety issue relating to one or more occupants of a vehicle are disclosed. Occupant(s) in a vehicle may not have their seatbelts securely fastened or even if their seatbelts are fastened, occupant(s) may not have their seatbelts positioned properly across their body. In some cases, occupant(s) may not be sitting safely in their seats. As an example, a child passenger may have unfastened their seatbelt or moved the seatbelt strap from their torso. All these instances may cause a safety issue and may pose a risk to the occupant(s).

A current method for detecting whether a seatbelt of the occupant is securely fastened includes the use of seatbelt sensors to determine whether the latch plate of the seatbelt is locked into the buckle of the seatbelt. However, an occupant may fasten the seatbelt and place a portion of the seatbelt strap, such as the portion that rests across the torso, behind their back. In such a case, the seatbelt sensor is unable to detect that the seat belt of the occupant is not securely fastened across the occupant.

Another current method for detecting whether the seatbelt of the occupant is securely fastened includes using vehicle cameras. However, in a case where the occupant is holding an object such as a laptop or a large book, the images or videos captured by the vehicle cameras may not include the torso of the occupant which is occluded by the object, which is between the vehicle camera and the occupant. Another current method for detecting whether the seatbelt of the occupant is securely fastened includes using radar sensors. However, in a case where the occupant is holding an object that has metal such as a laptop, the radar sensor is unable to pass through metal and as such, a portion of the occupant would be occluded by the metal in the object. These current methods may be unable to detect and determine whether the occupant has their seatbelt safely and securely fastened.

Accordingly, in one embodiment, the disclosed approach is a system that determines whether there is a safety issue relating to one or more occupants of a vehicle. The system may include one or more vehicle sensors capable of capturing first sensor data relating to the occupant(s) in the vehicle, object(s) in the vehicle, and/or the vehicle cabin. Examples of vehicle sensors include radar sensors, LiDAR sensors, thermal sensors, and/or cameras. The system requests and receives first sensor data from the vehicle sensors. The system determines whether the seatbelts of the occupants are securely fastened and are properly placed across the body of the occupant. The system may further determine whether the occupants are sitting properly in their seats. The system may determine that there are one or more occupants for which the system cannot determine the positioning or placement of the seatbelt and/or cannot determine whether the occupant is sitting down properly because an object occludes a portion of the occupant. As an example, the object may be a mobile device such as a mobile phone, a computer, a laptop, a tablet, a camera, a display unit, and/or a video player. More generally, the object may be anything that the vehicle sensor(s) cannot perceive through.

The system may then detect one or more mobile devices that are capable of capturing second sensor data in the vehicle. The second sensor data also relates to the occupant(s) in the vehicle, object(s) in the vehicle, and/or the vehicle cabin. However, based on the location of the mobile device, the sensors in the mobile device may be capable of capturing second sensor data that differs from the first sensor data in terms of perspective and/or field of view. The system may communicate with one or more of the mobile devices, requesting the second sensor data. In one case, the system may determine which mobile device to communicate with based on the location of the mobile device within the vehicle cabin. In another case, the system may communicate with the mobile devices in a round-robin manner, determining which of the mobile devices can provide second sensor data in which the portion of the occupant that is occluded in the first sensor data is visible.

The system may then determine whether there is a safety issue in which the seatbelts of the occupants are properly placed, securely fastened and/or the occupants are properly seated. The system may issue a notification indicating that there is or there is no safety issue based on the system determining that there is or there is no safety issue. Additionally, the system may operate the vehicle based upon the determination that there is or there is no safety issue. As an example, the system may prevent the vehicle from being started until the safety issues have been resolved. The system may be utilized when the vehicle is stationary or when the vehicle is in motion. The system may periodically determine whether there is a safety issue multiple times while the vehicle is in motion. Further, the system may be utilized for determining a safety issue pertaining to one or more occupants at a time.

The embodiments disclosed herein present various advantages over the current methods. First, the embodiments determine whether the seatbelt of one or more occupants is properly fastened and positioned on the occupant with higher accuracy than the current methods. Second, the embodiments control the vehicle based on whether there is a safety issue or there is no safety issue. Third, the embodiments utilize sensors in mobile devices within the vehicle and do not require additional hardware or computing resources.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

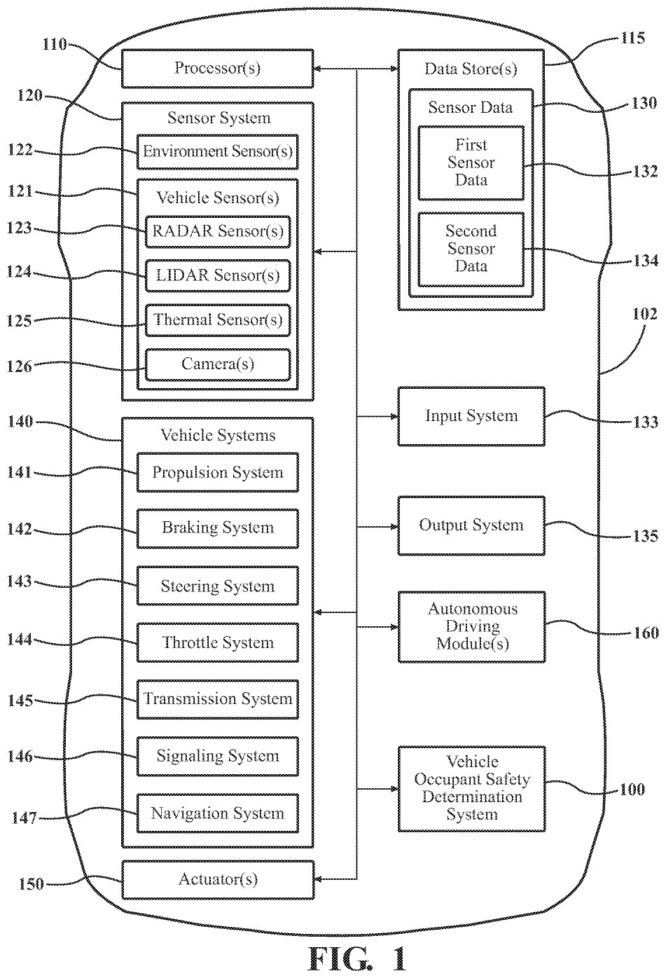

Referring to FIG. 1, a block diagram of the vehicle 102 incorporating a vehicle occupant safety determination system 100 is illustrated. The vehicle 102 includes various elements. It will be understood that in various embodiments, it may not be necessary for the vehicle 102 to have all of the elements shown in FIG. 1. The vehicle 102 can have any combination of the various elements shown in FIG. 1. Further, the vehicle 102 can have additional elements to those shown in FIG. 1. In some arrangements, the vehicle 102 may be implemented without one or more of the elements shown in FIG. 1. While the various elements are shown as being located within the vehicle 102 in FIG. 1, it will be understood that one or more of these elements can be located external to the vehicle 102. Further, the elements shown may be physically separated by large distances. For example, one or more components of the vehicle occupant safety determination system 100 can be implemented within the vehicle 102 while further components of the vehicle occupant safety determination system 100 are implemented within a cloud-computing environment. In such an example, the vehicle occupant safety determination system 100 may acquire data from a mobile device and the vehicle 102 and execute as a cloud-based resource that is comprised of devices (e.g., distributed servers) remote from the vehicle 102 to determine a safety issue relating to one or more occupants of the vehicle 102. It should be appreciated that apportionment of the processing between the vehicle 102 and a cloud server may vary according to different implementations.

In one or more embodiments, the vehicle 102 can be a conventional vehicle that is configured to operate in only a manual mode. In one or more embodiments, the vehicle 102 can be an autonomous vehicle. As used herein, “autonomous vehicle” refers to a vehicle that operates in an autonomous mode. “Autonomous mode” refers to navigating and/or maneuvering the vehicle 102 along a travel route using one or more computing systems to control the vehicle 102 with minimal or no input from a human driver. In one or more embodiments, the vehicle 102 can be highly automated or completely automated. In one or more embodiments, the vehicle 102 can be configured with one or more semi-autonomous operational modes in which one or more computing systems perform a portion of the navigation and/or maneuvering of the vehicle 102 along a travel route, and a vehicle operator (i.e., driver) provides inputs to the vehicle 102 to perform a portion of the navigation and/or maneuvering of the vehicle 102 along a travel route.

The vehicle 102 can include one or more processors 110. In one or more arrangements, the processor(s) 110 can be a main processor of the vehicle 102. For instance, the processor(s) 110 can be an electronic control unit (ECU). The vehicle 102 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the data store(s) 115 can include sensor data 130. The sensor data 130 may include first sensor data 132 that originates from a sensor system 120 of the vehicle 102 and second sensor data 134 that originates from one or more mobile devices. The first sensor data 132 may include sensor data from vehicle sensors 121, environment sensors 122, and/or any other suitable sensors in the vehicle 102. The second sensor data 134 may include sensor data from mobile devices such as a mobile phone, a computer, a laptop computer, a tablet computer, a display unit, a camera, and/or a video player such as a DVD player. In general, the mobile device may include any device capable of capturing an image and/or a video. In some instances, one portion of the sensor data 130 may be located in the data store(s) 115 located onboard the vehicle 102 and another portion of the sensor data 130 may be located in storage outside the vehicle 102.

The vehicle 102 may include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor 110 to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 102 (including any of the elements shown in FIG. 1).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 102 and/or an event inside the vehicle 102, such as in the vehicle cabin. The vehicle sensor(s) 121 can detect and/or record the time an event occurred. In one or more arrangements, the vehicle sensor(s) 121 can be configured to detect and/or sense position, orientation, and movement of occupants of the vehicle 102.

The vehicle sensor(s) 121 can include one or more radar sensors 123. The radar sensor(s) 123 can be located in the vehicle cabin and can detect the position and/or the movement of occupant(s) inside the vehicle cabin. The vehicle sensor(s) 121 can include one or more LiDAR sensors 124. The LiDAR sensor(s) 124 can be located in the vehicle cabin and can detect the position and/or the movement of occupant(s) inside the vehicle cabin. The vehicle sensor(s) 121 can include one or more thermal sensors 125. The thermal sensor(s) 125 can be located in the vehicle cabin and can detect the position and/or the movement of occupant(s) inside the vehicle cabin based on temperature.

The vehicle sensor(s) 121 can include one or more cameras 126. The camera(s) 126 can capture the position and/or the movement of the occupant(s) inside the vehicle cabin. The cameras 126 may capture images and/or video. In one or more arrangements and as example, the cameras 126 may be high dynamic range (HDR) cameras or infrared (IR) cameras.

Alternatively, or in addition, the sensor system 120 can include one or more environment sensors 122 configured to acquire, and/or sense driving environment data. “Driving environment data” includes data or information about the external environment in which the vehicle is located or one or more portions thereof. For example, the one or more environment sensors 122 can be configured to detect, measure, quantify and/or sense other objects in the external environment of the vehicle 102.

The vehicle 102 can include one or more vehicle systems 140. Various examples of the one or more vehicle systems 140 are shown in FIG. 1. However, the vehicle 102 can include more, fewer, or different vehicle systems 140. It should be appreciated that although particular vehicle systems are separately defined, each or any of the systems or portions thereof may be otherwise combined or segregated via hardware and/or software within the vehicle 102. The vehicle 102 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The vehicle 102 can include one or more actuators 150. The actuators 150 can be any element or combination of elements operable to modify, adjust and/or alter one or more of the vehicle systems 140 or components in response to receiving signals or other inputs from the processor(s) 110, the vehicle occupant safety determination system 100, and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 102 can include an input system 133. An “input system” includes any device, component, system, element or arrangement or groups thereof that enable information/data to be entered into a machine. The input system 133 can receive an input from a user (e.g., a driver or a passenger). The vehicle 102 can include an output system 135. An “output system” includes any device, component, or arrangement or groups thereof that enable information/data to be presented to a user (e.g., a person, a vehicle passenger, etc.) such as a display interface.

The vehicle 102 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 102 can include one or more autonomous driving modules 160. The autonomous driving module(s) 160 either independently or in combination with the vehicle occupant safety determination system 100 can be configured to determine travel path(s), current autonomous driving maneuvers for the vehicle 102, future autonomous driving maneuvers and/or modifications to current autonomous driving maneuvers based on data acquired by the sensor system 120, driving scene models, and/or data from any other suitable source such as determinations from the sensor data 130. “Driving maneuver” means one or more actions that affect the movement of a vehicle. Examples of driving maneuvers include accelerating, decelerating, braking, turning, moving in a lateral direction of the vehicle 102, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 102 or one or more systems thereof (e.g., one or more of vehicle systems 140).

As previously mentioned, the vehicle 102 can include the vehicle occupant safety determination system 100. The processor(s) 110 and/or the vehicle occupant safety determination system 100 can be operatively connected to communicate with the various vehicle systems 140 and/or individual components thereof. The vehicle occupant safety determination system 100 can determine a safety issue relating to one or more occupants in the vehicle 102. As an example, a safety issue may be fastening of a seat belt, positioning of the seat belt, and/or positioning of the one or more occupants.

In general, the vehicle occupant safety determination system 100 may utilize first sensor data 132 to determine whether there is a safety issue in relation to one or more occupants. The first sensor data 132 may originate from one or more vehicle sensors 121 and may include a view of one or more occupants. However, a portion of the occupants may be occluded by any number of objects such as a mobile device located between the vehicle sensor(s) 121 and the occupant(s). In a case where a portion of at least one of the occupants is occluded, the vehicle occupant safety determination system 100 may identify a device capable of capturing second sensor data 134 in the vehicle cabin. The vehicle occupant safety determination system 100 may request second sensor data 134 from the device and may then utilize the second sensor data 134 to determine whether there is a safety issue. The device may be the mobile device located between the vehicle sensor(s) 121 and the occupant(s).

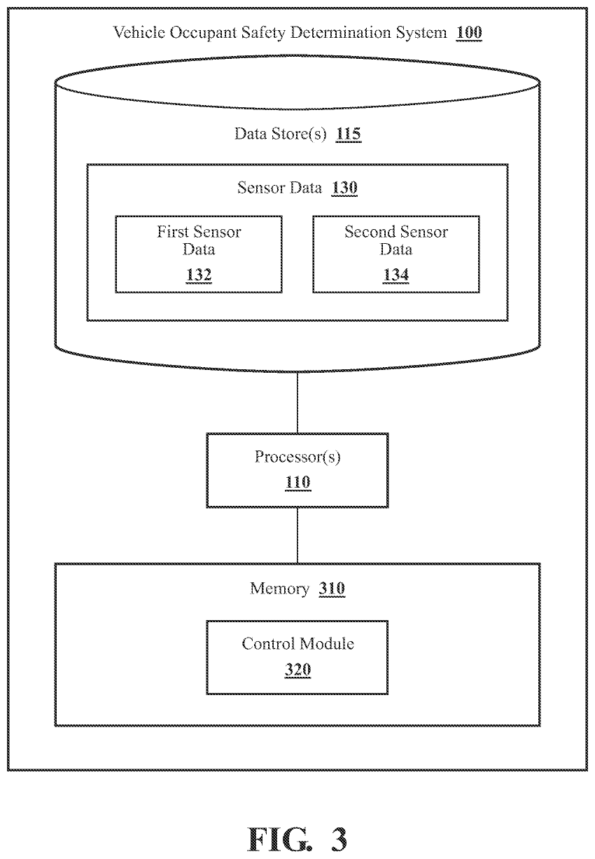

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 102 includes a vehicle occupant safety determination system 100 that is implemented to perform methods and other functions as disclosed herein for determining whether there is a safety issue relating to an occupant of a vehicle. As will be discussed in greater detail subsequently, the vehicle occupant safety determination system 100, in various embodiments, may be implemented partially within the vehicle 102 and may further exchange communications with additional aspects of the vehicle occupant safety determination system 100 that are remote from the vehicle 102 in support of the disclosed functions. Thus, while FIG. 3 generally illustrates the vehicle occupant safety determination system 100 as being self-contained, in various embodiments, the vehicle occupant safety determination system 100 may be implemented within multiple separate devices some of which may be remote from the vehicle 102.

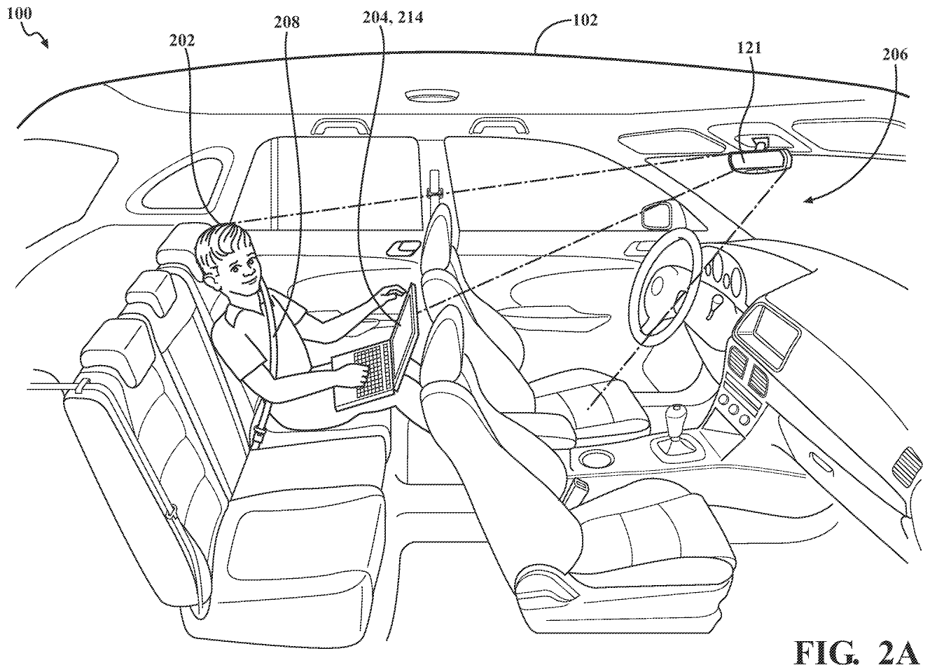

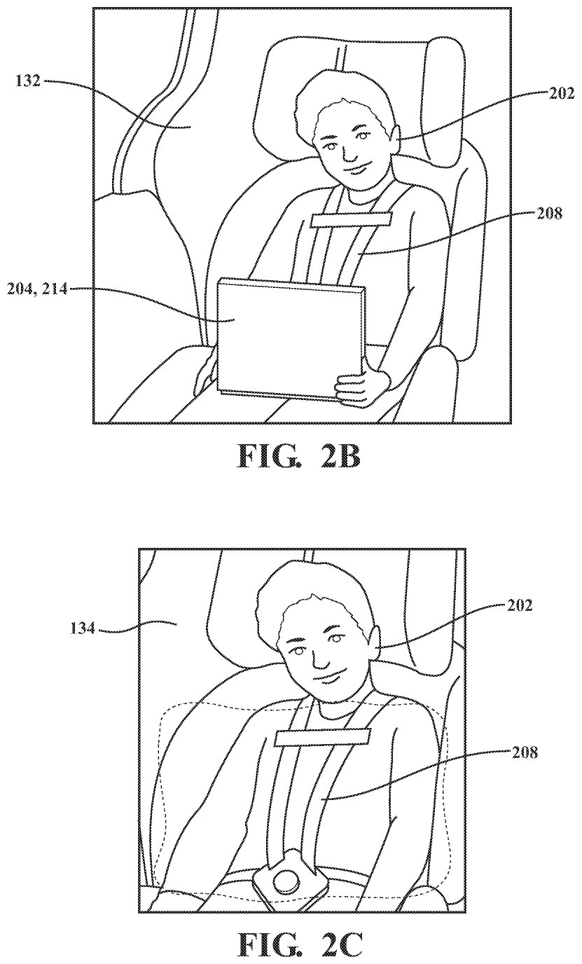

Referring to FIGS. 2A-2C, an example of a vehicle 102 incorporating a vehicle occupant safety determination system 100 as well as the first and second sensor data 132, 134 are illustrated. As previously mentioned, the vehicle 102 may include the vehicle occupant safety determination system 100 and one or more vehicle sensors 121. As shown in FIG. 2A, at least one or more occupants 202 are inside the vehicle. Additionally, at least one or more mobile devices 204 are inside the vehicle 102. For simplicity, a single occupant 202 holding a laptop 204 is shown in FIG. 2A.

As previously explained, the vehicle sensors 121 may include one or more of radar sensors 123, LiDAR sensors 124, thermal sensors 125, and/or cameras 126. The vehicle sensors 121 are located inside the vehicle cabin 206. The vehicle sensors 121 are capable of capturing first sensor data 132 relating to the vehicle cabin 206 and the occupant(s) 202 in the vehicle cabin 206. As such, the vehicle occupant safety determination system 100 may activate one or more of the vehicle sensors 121 to capture first sensor data 132 of the vehicle cabin 206 including the occupants 202 and/or objects 214 in the vehicle cabin 206. The vehicle sensor(s) 121 may capture the first sensor data 132 in any suitable format including images, video, and/or point cloud. As an example and as shown in FIG. 2B, the first sensor data 132 may be from the perspective of the vehicle sensor 121 and in an image format, in which a portion of the occupant 202 is visible and a portion of the occupant 202 is occluded by the laptop 204. The first sensor data 132 may then be stored in the data store 115.

The vehicle occupant safety determination system 100 may analyze the first sensor data 132 to determine the number of occupants 202 in the vehicle 102, identify the occupant(s) 202 in the vehicle 102, and/or determine whether the occupant(s) 202 are positioned safely such as sitting down properly and/or having their seatbelts 208 securely fastened. The vehicle occupant safety determination system 100 may utilize any suitable image processing, machine learning, and/or artificial intelligence methods or processes to make the determinations and/or identifications. The vehicle occupant safety determination system 100 may determine that a portion of one or more of the occupants 202 is occluded such that the vehicle occupant safety determination system 100 cannot make the determination of whether the occupant(s) 202 are positioned safely. In such a case, the vehicle occupant safety determination system 100 may search for a mobile device 204 to provide second sensor data 134 that may provide the portion of the occupant(s) 202 that is occluded in the first sensor data 132 such that the vehicle occupant safety determination system 100 may utilize the second sensor data 134 to determine whether the occupant(s) 202 are positioned safely.

The mobile devices 204 may include any device that is not a part of the vehicle 102 and/or is not permanently affixed to the vehicle 102 that is capable of capturing second sensor data 134. As an example, the mobile device 204 may be a personal device such as a mobile phone, a computer, a laptop, a tablet, a camera, a display unit, and/or a video player. The mobile device 204 may be positioned such that the mobile device 204 may be capable of capturing second sensor data 134 that relates to the occupants 202 and/or other objects 214 in the vehicle cabin 206. As such and as an example, an occupant 202 may be holding the mobile device 204 or resting the mobile device 204 on their legs. Alternatively and as an example, the mobile device 204 may be affixed to a surface inside the vehicle cabin 206 such as on the back of a vehicle seat. In such an example, the mobile device 204 may be affixed to the vehicle seat in a temporary manner such that the mobile device 204 may be easily removed.

The mobile device(s) 204 may be capable of communicating, receiving, transmitting, and/or broadcasting data. The vehicle occupant safety determination system 100 may send a signal to the mobile device 204 requesting the second sensor data 134. As an example, the vehicle occupant safety determination system 100 may send a signal to the mobile device 204 requesting the second sensor data 134. In response, the mobile device 204 may capture and/or transmit the second sensor data 134 which may include information of the occupant(s) 202, the vehicle cabin 206, and/or objects 214 in the vehicle 102. As another example, the vehicle occupant safety determination system 100 may send a signal to the mobile device 204 requesting to take control of the camera of the mobile device 204. In such an example, in response to the mobile device 204 granting access to the vehicle occupant safety determination system 100, the vehicle occupant safety determination system 100 may assume control of the camera of the mobile device 204. Subsequently, the vehicle occupant safety determination system 100 may capture the second sensor data 134 in the form of images and/or video. As an example and as shown in FIG. 2C, the second sensor data 134 may be from the perspective of the sensor in the mobile device 204 and in an image format, in which the portion of the occupant 202 that is occluded by the laptop 204 is visible.

The vehicle occupant safety determination system 100 may analyze the second sensor data 134 to determine the number of occupants 202 in the vehicle 102, identify the occupant(s) 202 in the vehicle 102, and/or determine whether the occupant(s) 202 are positioned safely such as sitting down properly and/or having their seatbelts 208 securely fastened. The vehicle occupant safety determination system 100 may utilize any suitable image processing, machine learning, and/or artificial intelligence methods or processes to make the determinations and/or identifications.

With reference to FIG. 3, a more detailed block diagram of the vehicle occupant safety determination system 100 is shown. The vehicle occupant safety determination system 100 may include a processor(s) 110. Accordingly, the processor(s) 110 may be a part of the vehicle occupant safety determination system 100, or the vehicle occupant safety determination system 100 may access the processor(s) 110 through a data bus or another communication pathway. In one or more embodiments, the processor(s) 110 is an application-specific integrated circuit that may be configured to implement functions associated with a control module 320. More generally, in one or more aspects, the processor(s) 110 is an electronic processor, such as a microprocessor that can perform various functions as described herein when loading the control module 320 and executing encoded functions associated therewith.

The vehicle occupant safety determination system 100 may include a memory 310 that stores the control module 320. The memory 310 may be a random-access memory (RAM), read-only memory (ROM), a hard disk drive, a flash memory, or other suitable memory for storing the control module 320. The control module 320 includes, for example, computer-readable instructions that, when executed by the processor(s) 110, cause the processor(s) 110 to perform the various functions disclosed herein. While, in one or more embodiments, the control module 320 is a set of instructions embodied in the memory 310, in further aspects, the control module 320 includes hardware, such as processing components (e.g., controllers), circuits, etc. for independently performing one or more of the noted functions.

The vehicle occupant safety determination system 100 may include a data store(s) 115 for storing one or more types of data. Accordingly, the data store(s) 115 may be a part of the vehicle occupant safety determination system 100, or the vehicle occupant safety determination system 100 may access the data store(s) 115 through a data bus or another communication pathway. The data store(s) 115 is, in one embodiment, an electronically based data structure for storing information. In at least one approach, the data store 115 is a database that is stored in the memory 310 or another suitable medium, and that is configured with routines that can be executed by the processor(s) 110 for analyzing stored data, providing stored data, organizing stored data, and so on. In either case, in one embodiment, the data store 115 stores data used by the control module 320 in executing various functions. In one embodiment, the data store 115 may be able to store sensor data 130 and/or other information that is used by the control module 320.

The data store(s) 115 may include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 may be a component of the processor(s) 110, or the data store(s) 115 may be operatively connected to the processor(s) 110 for use thereby. The term “operatively connected” or “in communication with” as used throughout this description, can include direct or indirect connections, including connections without direct physical contact.

In one or more arrangements, the data store(s) 115 can include first sensor data 132. The first sensor data 132 can originate from the sensor system 120 of the vehicle 102. The first sensor data 132 can include data from vehicle sensors 121 such as radar sensors 123, LiDAR sensors 124, thermal sensors 125, cameras 126, and/or any other suitable sensors in the vehicle 102 that are capable of capturing inside the vehicle cabin 206. The first sensor data 132 may include images, videos, and/or point clouds of the vehicle cabin 206, occupants 202 in the vehicle cabin 206, and/or objects 214 in the vehicle cabin 206.

In one or more arrangements, the data store(s) 115 can include second sensor data 134. The second sensor data 134 can originate from one or more mobile devices 204 located in the vehicle 102. Similar to the first sensor data 132, the second sensor data 134 may include images, videos, and/or point clouds of the vehicle cabin 206, occupants 202 in the vehicle cabin 206, and/or objects 214 in the vehicle cabin 206.

In one embodiment, the control module 320 may include instructions that, when executed by the processor(s) 110, cause the processor(s) 110 to request, in response to a portion of an occupant 202 being occluded in the first sensor data 132 captured from a vehicle sensor 121 in a vehicle cabin 206, a second sensor data 134 from a mobile device 204 capable of capturing second sensor data 134 in the vehicle cabin 206. In one or more arrangements, the control module 320 may receive first sensor data 132 from the vehicle sensor(s) 121. As previously mentioned, the vehicle sensor(s) 121 may be one or more of a radar sensor 123, a camera 126, a LiDAR sensor 124, a thermal sensor 125, and/or any sensor suitable and capable of capturing sensor data 130 relating to the vehicle cabin 206. The control module 320 may identify the occupant(s) 202 in the vehicle 102 based on the first sensor data 132. The control module 320 may then determine whether there is a safety issue relating to one or more of the occupants 202. A safety issue may include fastening of the seatbelt 208, positioning of the seatbelt 208, and/or positioning of the occupant 202. In other words, the control module 320 may determine whether the occupant 202 has their seatbelt 208 securely fastened, whether the seatbelt 208 is properly positioned across the occupant's 202 body, and/or whether the occupant 202 is seated in a proper and safe manner based on the first sensor data 132. As previously mentioned, the control module 320 may utilize any suitable image processing, machine learning, and/or artificial intelligence method to determine whether there is a safety issue relating to one or more of the occupants 202 of the vehicle 102.

In one or more cases, an object 214 may be between the occupant 202 and the vehicle sensor(s) 121. As such, the object 214 may be blocking the vehicle sensor's 121 view of the occupant(s) 202. As an example, the occupant 202 may have a mobile device 204 such as a laptop blocking the view of the vehicle sensor(s) 121, thus a portion of the occupant 202 may be occluded in the first sensor data 132. In such a case, the control module 320 may be unable to determine whether there is a safety issue and may request second sensor data 134 from the mobile device 204. Alternatively and additionally, the control module 320 may request second sensor data 134 from another mobile device other than the mobile device 204 blocking the view of the vehicle sensor(s) 121. In other words, the vehicle sensors' 121 view of the occupant(s) 202 may be occluded by an object 214. In one case, the object 214 may be a mobile device 204 capable of capturing sensor data 130. In another case, the object 214 may not be capable of capturing sensor data 130. The control module 320 may detect one or more mobile devices 204 in the vehicle 102 and may then request second sensor data 134 from the mobile devices 204.

In one or more arrangements, the control module 320 may detect multiple mobile devices 204 in the vehicle 102 and may then select one mobile device 204 from the multiple mobile devices 204. The control module 320 may detect the mobile device 204 from the multiple mobile devices 204 in the vehicle cabin 206 using any suitable method. The mobile device 204 may be a mobile phone, a computer such as a laptop or a tablet, a display unit such as a video player, and/or a camera. The control module 320 may request and receive second sensor data 134 from the selected mobile device 204 and may determine whether the portion of the occupant 202 that is occluded in the first sensor data 132 is visible in the second sensor data 134. The control module 320 may utilize any suitable image processing, machine learning, and/or artificial intelligence techniques to determine whether the portion of the occupant 202 that is occluded in the first sensor data 132 is visible in the second sensor data 134. In a case where the control module 320 determines that the occluded portion is not visible in the second sensor data 134, the control module 320 may select another mobile device 204 from the multiple mobile devices 204. The control module 320 may then request and receive second sensor data 134 from the newly selected mobile device 204 and may determine whether the portion of the occupant 202 that is occluded in the first sensor data 132 is visible in the second sensor data 134. In a case where the control module 320 determines that the occluded portion is not visible in the second sensor data 134, the control module 320 may continue to select other mobile devices 204 from the multiple devices 204. The control module 320 may continue to request and receive second sensor data 134 from the selected mobile devices 204 until the control module 320 determines that the occluded portion is visible in the second sensor data 134.

In one or more arrangements, the control module 320 may detect a mobile device 204 in the first sensor data 132. The control module 320 may then determine the location of the mobile device 204 within the vehicle cabin 206 based on the location of the mobile device 204 in the first sensor data or using any other suitable methods. The control module 320 may then communicate with and establish a connection with the mobile device 204. The control module 320 may request permission to connect to the mobile device 204 and may further request and receive second sensor data 134 from the mobile device 204. In one case, the control module 320 may request and receive the second sensor data 134 from the mobile device 204. In another case, the control module 320 may request and assume control of the mobile device 204. The control module 320 may then capture the second sensor data 134 using the sensor(s) in the mobile device 204.

In one embodiment, the control module 320 may include instructions that, when executed by the processor(s) 110, cause the processor(s) 110 to determine, in response to the portion of the occupant 202 that is occluded in the first sensor data 132 being visible in the second sensor data 134, whether there is a safety issue. As previously mentioned, the control module 320 may determine whether the portion of the occupant 202 that is occluded in the first sensor data 132 is visible in the second sensor data 134 using any suitable method including image processing, machine learning, and/or artificial intelligence methods. The control module 320 may determine the seat that the occupant 202 with an occluded portion is sitting in in the vehicle 102 using information from sensors including other vehicle sensors such as seat sensors or weight sensors. The control module 320 may then determine whether the field of view of the second sensor data 134 includes a view of the determined seat. As such, the control module 320 may determine whether the portion of the occupant 202 that is occluded in the first sensor data 132 is visible in the second sensor data 134.

Upon determining that the portion of the occupant 202 that is occluded in the first sensor data 132 is visible in the second sensor data 134, the control module 320 may determine whether there is a safety issue relating to the occupant 202. The control module 320 may utilize any suitable methods to determine whether the occupant 202 is positioned properly in their seat, e.g., sitting upright, whether the occupant 202 has their seatbelt 208 fastened, and/or whether the seatbelt 208 is positioned properly, e.g., a portion of the seatbelt 208 across the occupant's 202 pelvis and another portion of the seatbelt 208 across the occupant's 202 torso.

In a case where these conditions are met, the control module 320 may determine that there is no safety issue and the control module 320 may generate a notification indicating that there is no safety issue and the occupant 202 is securely fastened. In a case where one or more of these conditions are not met, the control module 320 may also generate a notification, indicating that there is a safety issue and may further indicate the safety issue, e.g., the occupant's 202 seatbelt 208 is not securely fastened, the straps of the seatbelt 208 are not properly positioned, and/or the occupant 202 is not sitting properly. The control module 320 may output the notification in any suitable manner including an audio output or a visual output such as an image, a video or a text.

Alternatively and/or additionally, in a case where these conditions are met, the control module 320 may determine that there is no safety issue, and the control module 320 may implement a vehicle action in response to no safety issue and the occupant 202 being securely fastened. In a case where one or more of these conditions are not met, the control module 320 may also implement a vehicle action in response to a safety issue such as the occupant's 202 seatbelt 208 not being securely fastened, the straps of the seatbelt 208 not being properly positioned, and/or the occupant 202 not sitting properly. The vehicle action may include starting the vehicle 102, stopping the vehicle 102, decelerating, and/or accelerating. As an example, the vehicle 102 may be stationary, and the control module 320 may determine that there is no safety issue before starting the vehicle 102 and/or activating the autonomous driving module(s) 160. As another example, in response to determining that there is a safety issue and the vehicle 102 is in motion, the control module 320 may decelerate and/or stop the vehicle 102. As another example, in response to determining that there is no safety issue and the vehicle 102 is in motion, the control module 320 may cause the vehicle 102 to accelerate or make a turn.

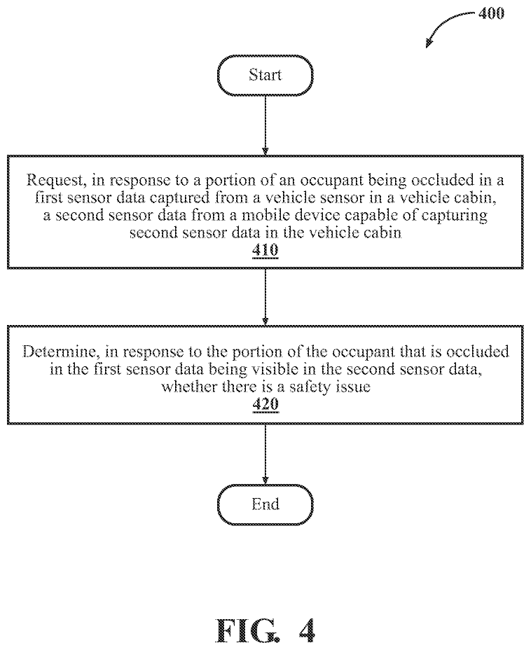

FIG. 4 illustrates a method 400 for determining a safety issue relating to an occupant 202 of a vehicle 102. The method 400 will be described from the viewpoint of the vehicle occupant safety determination system 100 of FIGS. 1-3. However, the method 400 may be adapted to be executed in any one of several different situations and not necessarily by the vehicle occupant safety determination system 100 of FIGS. 1-3.

At step 410, the vehicle occupant safety determination system 100 may request, in response to a portion of an occupant 202 being occluded in a first sensor data 132 captured from a vehicle sensor 121 in a vehicle cabin 206, a second sensor data 134 from a mobile device 204 capable of capturing second sensor data 134 in the vehicle cabin 206. As previously mentioned, the vehicle occupant safety determination system 100 may receive first sensor data 132 from one or more vehicle sensors 121. The vehicle sensors 121 may be one or more of a radar sensor 123, a camera 126, a LiDAR sensor 124, and/or a thermal sensor 125.

The vehicle occupant safety determination system 100 may determine that portions of one or more occupants 202 in the vehicle 102 are occluded in the first sensor data 132. The vehicle occupant safety determination system 100 may determine which seats in the vehicle 102 have occupants 202 with occluded portions using, as an example, one or more sensors or the first sensor data 132. The vehicle occupant safety determination system 100 may then determine which mobile devices 204 are proximate to those seats and communicate with the mobile device(s) 204, requesting second sensor data 134 from the mobile device 204 and/or requesting to take control of the mobile device 204 so as to capture second sensor data 134. In response to the request, the mobile device(s) 204 may transmit and the vehicle occupant safety determination system 100 may receive second sensor data 134. The vehicle occupant safety determination system 100 may communicate and receive second sensor data 134 from one or more mobile devices 204. The vehicle occupant safety determination system 100 may determine whether the portion of the occupant(s) 202 that is occluded in the first sensor data 132 is visible in any of the second sensor data 134 using any suitable image processing, machine learning, and/or artificial intelligence techniques.

At step 420, the vehicle occupant safety determination system 100 may determine, in response to the portion of the occupant 202 that is occluded in the first sensor data 132 being visible in the second sensor data 134, whether there is a safety issue. Upon receiving second sensor data 134 in which the occluded portion in the first sensor data 132 is visible, the vehicle occupant safety determination system 100 determines whether there is a safety issue. As previously mentioned, a safety issue may be related to the fastening of a seatbelt 208, the positioning of the seatbelt 208 on the occupant 202, and/or the positioning of the occupant 202. As an example, the vehicle occupant safety determination system 100 may compare the images of the seatbelt 208 and/or occupant 202 to an image database to determine whether the seatbelt 208 is securely fastened, the seatbelt 208 is properly positioned, and/or the occupant 202 is properly positioned. The vehicle occupant safety determination system 100 may generate a notification and/or implement a vehicle action in response to the determination that there is a safety issue. Alternatively and/or additionally, the vehicle occupant safety determination system 100 may generate a notification and/or implement a vehicle action in response to the determination that there is no safety issue. The notification may be audio, visual, a vibration, or any other suitable notification method. The vehicle action may include starting the vehicle 102, stopping the vehicle 102, activating and/or deactivating a vehicle system such as autonomous driving modules, entertainment systems, accelerating, decelerating, and/or steering the vehicle 102.

It will be appreciated that arrangements described herein can provide numerous benefits, including one or more of the benefits mentioned herein. For example, arrangements described herein can result in keeping and ensuring the safety of occupants of a vehicle.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, the system comprising:
a processor; and
a memory storing machine-readable instructions that, when executed by the processor, cause the processor to:
request, in response to a portion of an occupant being occluded in a first sensor data captured from a vehicle sensor in a vehicle cabin, a second sensor data from a mobile device capable of capturing second sensor data in the vehicle cabin; and
determine, in response to the portion of the occupant that is occluded in the first sensor data being visible in the second sensor data, whether there is a safety issue.

2. The system of claim 1, wherein the vehicle sensor includes one or more of:
a radar sensor;
a camera;
a LiDAR sensor; or
a thermal sensor.

3. The system of claim 1, wherein the safety issue includes one or more of:
fastening of a seatbelt;
positioning of a seatbelt; or
positioning of the occupant.

4. The system of claim 1, wherein the machine-readable instructions further include instructions that when executed by the processor cause the processor to:
detect the mobile device from a plurality of mobile devices in the vehicle cabin.

5. The system of claim 1, wherein the machine-readable instructions further include instructions that when executed by the processor cause the processor to:
generate, in response to a safety issue, a notification.

6. The system of claim 1, wherein the machine-readable instructions further include instructions that when executed by the processor cause the processor to:
implement, in response to a safety issue, a vehicle action.

7. The system of claim 1, wherein the mobile device includes one or more of:
a mobile phone;
a computer;
a tablet;
a display unit; or
a camera.

8. A method, the method comprising:
requesting, in response to a portion of an occupant being occluded in a first sensor data captured from a vehicle sensor in a vehicle cabin, a second sensor data from a mobile device capable of capturing second sensor data in the vehicle cabin; and
determining, in response to the portion of the occupant that is occluded in the first sensor data being visible in the second sensor data, whether there is a safety issue.

9. The method of claim 8, wherein the vehicle sensor includes one or more of:
a radar sensor;
a camera;
a LiDAR sensor; or
a thermal sensor.

10. The method of claim 8, wherein the safety issue includes one or more of:
fastening of a seatbelt;
positioning of a seatbelt; or
positioning of the occupant.

11. The method of claim 8, further comprising:
detecting the mobile device from a plurality of mobile devices in the vehicle cabin.

12. The method of claim 8, further comprising:
generating, in response to a safety issue, a notification.

13. The method of claim 8, further comprising:
implementing, in response to a safety issue, a vehicle action.

14. The method of claim 8, wherein the mobile device includes one or more of:
a mobile phone;
a computer;
a tablet;
a display unit; or
a camera.

15. A non-transitory computer-readable medium including instructions that when executed by a processor cause the processor to:
request, in response to a portion of an occupant being occluded in a first sensor data captured from a vehicle sensor in a vehicle cabin, a second sensor data from a mobile device capable of capturing second sensor data in the vehicle cabin; and
determine, in response to the portion of the occupant that is occluded in the first sensor data being visible in the second sensor data, whether there is a safety issue.

16. The non-transitory computer-readable medium of claim 15, wherein the vehicle sensor includes one or more of:
a radar sensor;
a camera;
a LiDAR sensor; or
a thermal sensor.

17. The non-transitory computer-readable medium of claim 15, wherein the safety issue includes one or more of:
fastening of a seatbelt;
positioning of a seatbelt; or
positioning of the occupant.

18. The non-transitory computer-readable medium of claim 15, wherein the instructions further include instructions that when executed by the processor cause the processor to detect the mobile device from a plurality of mobile devices in the vehicle cabin.

19. The non-transitory computer-readable medium of claim 15, wherein the instructions further include instructions that when executed by the processor cause the processor to generate, in response to a safety issue, a notification.

20. The non-transitory computer-readable medium of claim 15, wherein the instructions further include instructions that when executed by the processor cause the processor to implement, in response to a safety issue, a vehicle action.
